(19) United States
(12) Patent Application Publication
(10) Pub. No.: US 2003/0003876 A1
(43) Pub. Date: Jan. 2, 2003

(54) Multimedia PDA attachment unit

(76) Inventor: Daniel L. Rumsey, Inglewood, CA (US)

Correspondence Address: Michael J. Ram, KOPPEL, JACOBS, PATRICK & HEYBL, Suite 107, 555 St. Charles Drive, Thousand Oaks, CA, 91360, US

(21) Appl. No.: 10/155,422

(22) Filed: May 22, 2002

Related U.S. Application Data
(60) Provisional application No. 60/293,436, filed on May 24, 2001.

(51) Int. Cl. H04B 1/40

(52) U.S. Cl. 455/74; 455/556

(57) ABSTRACT

A multimedia PDA attachment unit for allowing users to precisely control multimedia equipment in their home or office by simply attaching the multimedia PDA attachment unit to their PDA and downloading the necessary programs and data. The PDA attachment unit comprises means of communication with a PDA and a means of communication with the multimedia equipment to be controlled. The PDA attachment unit utilizes PDA software and database information, which are downloaded from a computer. Computer software allows the user to enter information about the multimedia equipment, which is to be controlled and formats the data used with the PDA software and the PDA attachment unit. The PDA and PDA attachment unit generally have a built in receiver, which receives specific commands from a remote control to control its functionality.

This application claims benefit of Provisional Application Serial No. 60/293,436 filed May 24, 2001.

### 1. FIELD

In general, the invention relates to a programmable remote control. In particular, the invention relates to a Personal Digital Assistant (PDA) attachment unit that allows users to control electrical/electronic devices and equipment. More specifically the PDA attachment unit is used to control multimedia equipment through coupling of the PDA attachment unit to a PDA and downloading the necessary programs and data.

### 2. DESCRIPTION OF THE PRIOR ART

It can be appreciated that programmable remote controls have been in use for a number of years. Typically, a manufacturer provides a programmable remote control to control particular types of multimedia equipment supplied by that manufacturer. In addition, other types of programmable remote controls include universal remote controls that can control a variety of electronic or multimedia equipment types.

The main disadvantage associated with conventional programmable remote controls is that these remote controls do not have a friendly or intuitive user interface when performing complex control functions. Another disadvantage with conventional programmable remote controls is that a complex control function requires the user to know the details of which commands to send and also the sequence in which to send them. Other disadvantages with conventional programmable remote controls are that they neither support bi-directional communications nor make use of the built-in database capability of a PDA or similar computer based devices to control multimedia equipment.

In these respects, the PDA attachment unit according to the invention substantially departs from the conventional concepts and designs of the prior art, and in so doing provides an apparatus primarily developed for the purpose of allowing users to precisely control all equipment and particularly multimedia equipment in a home or office.

### SUMMARY

In view of the foregoing disadvantages inherent in the known types of programmable remote controls now present in the prior art, the present invention provides a new PDA attachment unit construction wherein the unit can be utilized by users to precisely control equipment particularly multimedia in a home or office by simply attaching the PDA attachment unit to a PDA and downloading the necessary programs and data.

The general purpose of the present invention, described for one specific application namely, multimedia equipment is to provide a new multimedia PDA attachment unit that has many of the advantages of the programmable remote control mentioned heretofore as well as many novel features that result in a new multimedia control system which is not anticipated, rendered obvious, suggested, or even implied by any of the prior art programmable remote control devices, either alone or in any combination thereof.

To attain this, the present invention generally comprises a PDA attachment unit having a means of communication with a PDA unit and a means of communication with the equipment to be controlled. The attachment unit utilizes PDA software and database information which are downloaded from a computer. Computer software allows the user to enter information about the equipment that is to be controlled and formats the data used with the PDA software and PDA attachment unit. The PDA attachment unit attaches to a PDA and contains a microprocessor, an IRDA, serial, or USB port to communicate with the PDA and an IR or RF transceiver to communicate with the equipment. PDA software is written that allows the PDA to present visual items (e.g., graphical objects, character strings, etc.) to a user, which when selected, communicates specific commands to the PDA attachment unit. These units generally have a built in receiver, which receives specific commands from a remote control unit to control its functionality. Some multimedia equipment can also transmit information to the attachment unit. Computer software is written that takes in user data about the equipment and translates it to a form that can be utilized by the PDA Software and PDA attachment unit.

There has thus been outlined, rather broadly, the more important features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary objective of the invention is to provide a PDA attachment unit that will overcome the shortcomings of the prior art devices.

Another objective of the present invention is to provide a PDA attachment unit for allowing users to precisely control all multimedia equipment in a home or office by simply attaching the PDA attachment unit to a PDA and downloading the necessary programs and data.

Another objective is to provide a PDA attachment unit that gives commercially available hand-held computers (PDAs) the capability to intelligently control multimedia equipment from a distance.

Another objective is to provide a PDA attachment unit that communicates with a PDA via its IRDA, serial or USB port and communicates with multimedia gear via infrared, or RF.

Another objective is to provide a PDA attachment unit that presents a user with a simple intuitive interface for multimedia equipment control.

Another objective is to provide a PDA attachment unit that can take database information from a PDA and translate it to control commands that are understood by multimedia equipment.

Another objective is to provide a PDA attachment unit that can receive status commands from multimedia gear that have the capability to send such commands and then to display information regarding the equipment to the user on his PDA.

Another objective is to provide a PDA attachment unit that allows a user to use his PDA as the user interface to a home automation system.

Another objective is to provide a PDA attachment unit that learns the infrared or RF command codes that controls the different manufactures multimedia equipment.

Other objectives of the invention will become obvious to the reader and it is intended that these objects and advantages are within the scope of the present invention.

To the accomplishment of the above and related advantages, this invention may be embodied in the form illustrated in the accompanying drawings, attention being called to the fact, however, that the drawings are illustrative only, and that changes may be made in the specific construction illustrated.

### BRIEF DESCRIPTION OF THE DRAWINGS

Various other features and advantages of the invention will become fully appreciated as the same becomes better understood when considered in conjunction with the accompanying drawings, in which like reference characters designate the same or similar parts throughout the several views, and wherein:

FIG. 1 is a block diagram of an exemplary embodiment of a system inclusive of a PDA, a PDA attachment unit in accordance with the invention, multimedia equipment, and a computer.

FIG. 2A is a partial perspective view of an exemplary embodiment of the PDA attachment unit mounted on the PDA of FIG. 1.

FIG. 2B is a partial perspective view of an exemplary embodiment of the PDA attachment unit and the PDA of FIG. 1 before attachment to each other.

FIG. 3 is an exemplary embodiment of a flowchart outlining the operations of software residing in the PDA attachment unit.

FIG. 4 is an exemplary embodiment of a flowchart of a programmable method of the operations, in normal operation, when a user selects a screen object in accordance with the invention.

FIG. 5A is an exemplary embodiment of a PDA screen showing a CD jukebox selection application.

FIG. 5B is an exemplary embodiment of a PDA screen showing a channels selection application.

FIG. 5C is an exemplary embodiment of a PDA screen showing a general control application.

FIG. 6A is an exemplary embodiment of a computer setup screen showing how multimedia equipment can be selected along with scripting for a CD jukebox application in accordance with the invention.

FIG. 6B is an exemplary embodiment of a computer setup screen showing a partial list of CD data that can be appropriately converted to one or more database types that the PDA software can recognize.

FIG. 7 is an exemplary embodiment of a computer setup screen showing a partial list of channels and channel scripts that can be pragmatically converted to PDA type databases.

FIG. 8A is an exemplary embodiment of a computer setup screen illustrating the selection of multimedia equipment.

FIG. 8B is an exemplary embodiment of a computer setup screen illustrating the selection of command and captions are assigned to general control functions.

FIG. 9 is an exemplary embodiment of a computer setup screen showing of one screen that is used when learning infrared control commands for multimedia equipment that is not in the software database.

FIG. 10 is an exemplary embodiment of a PDA screen that is used with the computer setup of FIG. 9 when learning infrared control commands for multimedia equipment that is not in the software database.

### DETAILED DESCRIPTION

An exemplary embodiment of the invention is a multimedia Personal Digital Assistant (PDA) attachment unit. Herein the multimedia PDA attachment unit comprises a fastening mechanism that provides an electrical and mechanical coupling to a PDA unit and logic that enables communications to both the PDA and the multimedia equipment. The PDA attachment unit is configured to store software written for the PDA and software written for a computer.

In the following description, certain terminology is used to describe features of the invention. For example, a “personal digital assistant” (PDA) is any type of hand-held computer that comprises one or more input and/or output devices implemented with a processing unit and software for processing data. Examples of a PDA include a PALM® organizer by Palm Computing, Inc. of Mountain View, Calif. or VISOR® by Handspring, Inc. of Palo Alto, Calif. “Logic” includes software and/or hardware (e.g., electrical/mechanical/optical devices or any combination thereof such as an opto-mechanical device). A “processing unit” includes hardware controlled at least in part by software to perform certain operations. Examples of a processing unit include a digital signal processor, a general microprocessor, a micro-controller, a state machine, an application specific integrated circuit and the like. “Software” is executable code configured as an operating system, an application, a downloadable applet, a routine, and the like.

The term “multimedia equipment” generally refers to any device that provides information in a visual, audible or another sensory nature to a user. Examples of multimedia equipment include a television, any type or collection of stereo components (e.g., tuner, compact disc “CD” player, tape deck), a video recorder, a digital video disk (DVD) player, MP3 player, a laser disk player, a set-top cable box, a satellite receiver, DSS, a security system or a home automation control system. The term “remote control” generally refers to a device containing a set of commands capable of being transmitted to multimedia equipment. Upon recognition of the commands, the multimedia equipment may either perform a predetermined event or respond with a transmission back to the remote control. The remote control may be provided by the multimedia equipment manufacturer, but can also be a universal type containing a library of codes to control the multimedia equipment of many different manufacturers.

Furthermore, a “link” is broadly defined as one or more information-carrying mediums to establish a communication pathway between (i) the PDA and a remotely located unit, (ii) a PDA attachment unit and multimedia equipment, and/or (iii) the PDA and the PDA attachment unit. For instance, the information-carrying medium may support wireless communications (e.g., infrared “IR”, laser, radio frequency “RF”, cellular, satellite, etc.) or communications over physical medium such as electrical wire, optical fiber, cable, bus traces and the like.

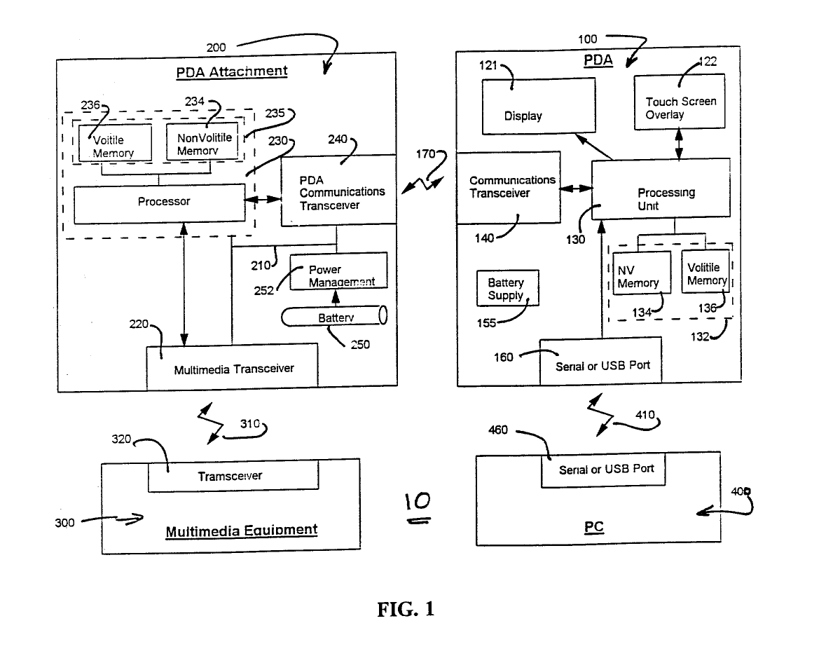

Referring to FIG. 1, a block diagram of an exemplary embodiment of a system 10 inclusive of a PDA 100 and a PDA attachment unit 200 for communication with multimedia equipment 300 and a computer 400 is shown. As illustrated herein, the PDA 100 is mechanically and communicatively coupled to the PDA attachment unit 200. In one embodiment, the PDA 100 is a commercially available hand-held computer powered by a battery 155. As shown, the PDA 100 comprises a display 121, a touch screen 122, a communications transceiver 140 such as an IRDA (Infrared Data Association) type, a processing unit 130 and internal memory 132. The internal memory 132 may include volatile memory 136 and/or non-volatile memory 134. The PDA 100 should also feature an output port 160 (e.g., a serial RS232, Universal Serial Bus “USB”, etc.). In lieu of the display 121, another type of output device may be used such as audio speakers if the PDA is voice controlled. Also, it is contemplated that the touch screen 122 may be substituted for any other data input device such as an alphanumeric keyboard, a keypad, dedicated buttons for menu scrolling and selection, and the like.

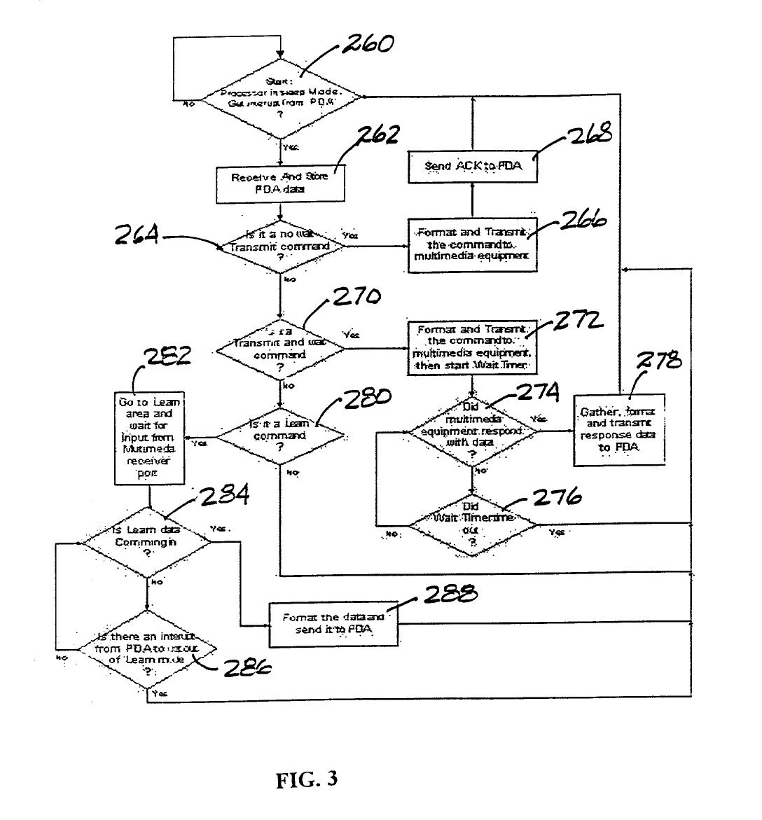

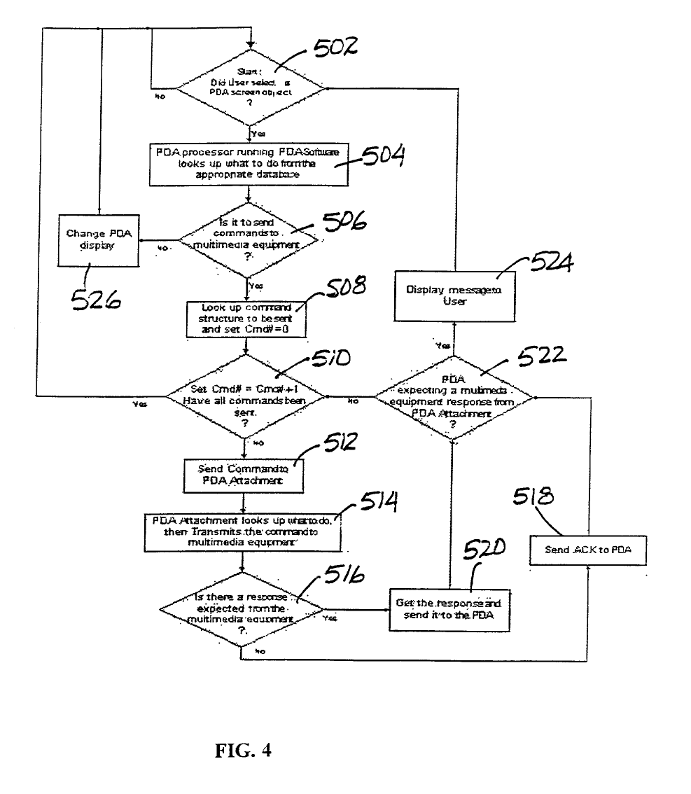

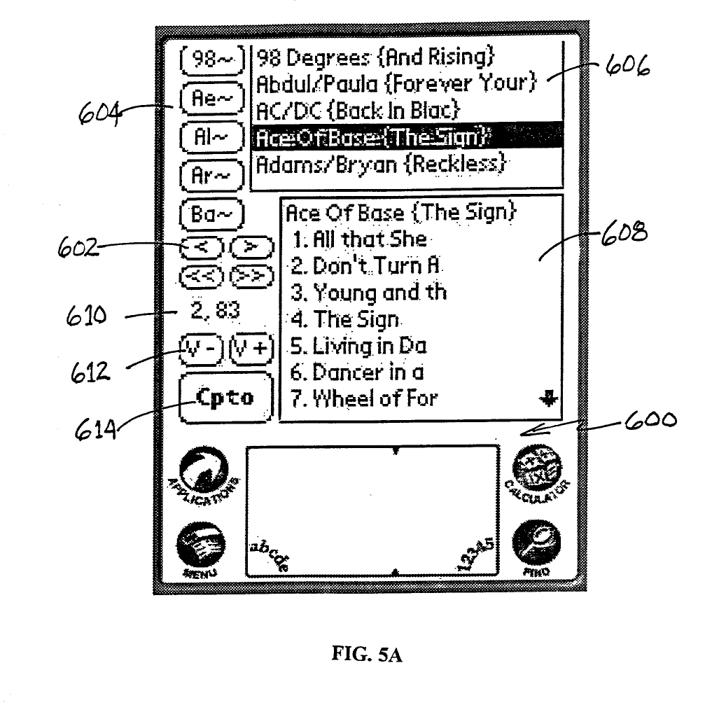

Although not shown, software for the PDA 100 (referred to as “PDA software”) is downloaded to, and resides in, the internal memory 132 and runs on top of an operating system of the PDA 100. In one embodiment, the PDA software is coded to utilize tools available with the operating system of the PDA 100, which preferably is PALM® OS based. The PDA software further allows the PDA 100 to present visual items (e.g., graphical objects, alphanumeric character strings, etc.) to a user, which when selected, communicates specific commands to the PDA attachment unit 200. The PDA software is also coded to (1) handle the transmission and reception of incoming information by the communications transceiver 140 via link 170, (2) manage the appearance of multimedia control items to a user on the display 121, (3) accept and process inputs via the user touch screen 122, and when necessary, (4) control communications with the computer 400 through the output port 160 and over link 410. When a Screen 121 object is selected, the PDA software looks up “what to do” from one or more of the downloaded user databases, detailed in Appendix A, which also reside in internal memory 132. As will be discussed later with FIGS. 3 and 4, “what to do” can include, but is not limited to, changing what is shown to the user on the display 121 to the user, or the sending of a command or commands to the PDA attachment unit 200.

It is contemplated that PDA software can be written for any existing or future PDA operating system, including but not limited to WINDOWS CE® from Microsoft Corporation of Redmond, Wash. The PDA software can also be coded to display items representative of any multimedia equipment or set of equipment a user may wish to control.

Referring still to FIG. 1, the PDA attachment unit 200 comprises a processing unit 230, a PDA communications transceiver 240 to communicate with the PDA 100, and a multimedia transceiver 220 to communicate with the multimedia equipment 300. Since the processing unit 230 supplies power to the transceivers 220 and 240, as an optional power saving feature, the PDA attachment unit 200 may further comprise one or more batteries 250 and power management logic 252 for voltage and current control. In particular, when the PDA attachment unit 200 is in a power conservation mode (e.g., SLEEP mode), the power management logic 252 enables the battery 250 to supply power to the receiver portions of both the PDA communications transceiver 240 and the multimedia transceiver 220. Likewise, when a signal from the PDA or multimedia equipment is detected by receiver portions of either the PDA communications transceiver 240 or the multimedia transceiver 220 (e.g., energy from an IR signal), an interrupt is sent to the processing unit 230. This interrupt indicates to the processing unit 230 to exit the power conservation mode and begin data processing.

The processing unit 230 comprises a processor 232 that runs control software contained in internal attachment memory 235 (e.g., nonvolatile memory 234) and utilizes volatile memory 236 for storing temporary data. In one embodiment, the processor 232, nonvolatile memory 234, and volatile memory 236 comprise a PIC microcontroller from Microchip Technologies, Inc. of Chandler, Ariz. The processor 232 directs communications with the PDA 100 via the PDA communications transceiver 240, which may be an IRDA transceiver. The processor 232 also directs the multimedia transceiver 220 to communicate over a link 310 with the multimedia equipment 300 through a transceiver 320 as shown. Since most multimedia equipment is infrared controlled, the multimedia transceiver 220 is preferably an infrared (IR) interface.

Alternatively, it is contemplated that the PDA attachment unit 200 may also communicate with the PDA 100 via a serial communication port (e.g., RS232 type port or RS485 type port), USB port, a RF communication channel and the like. Likewise, in lieu of the multimedia transceiver 220 being an IR interface, it may be configured as an RF transceiver to communicate with and control multimedia equipment 300 that has an RF interface.

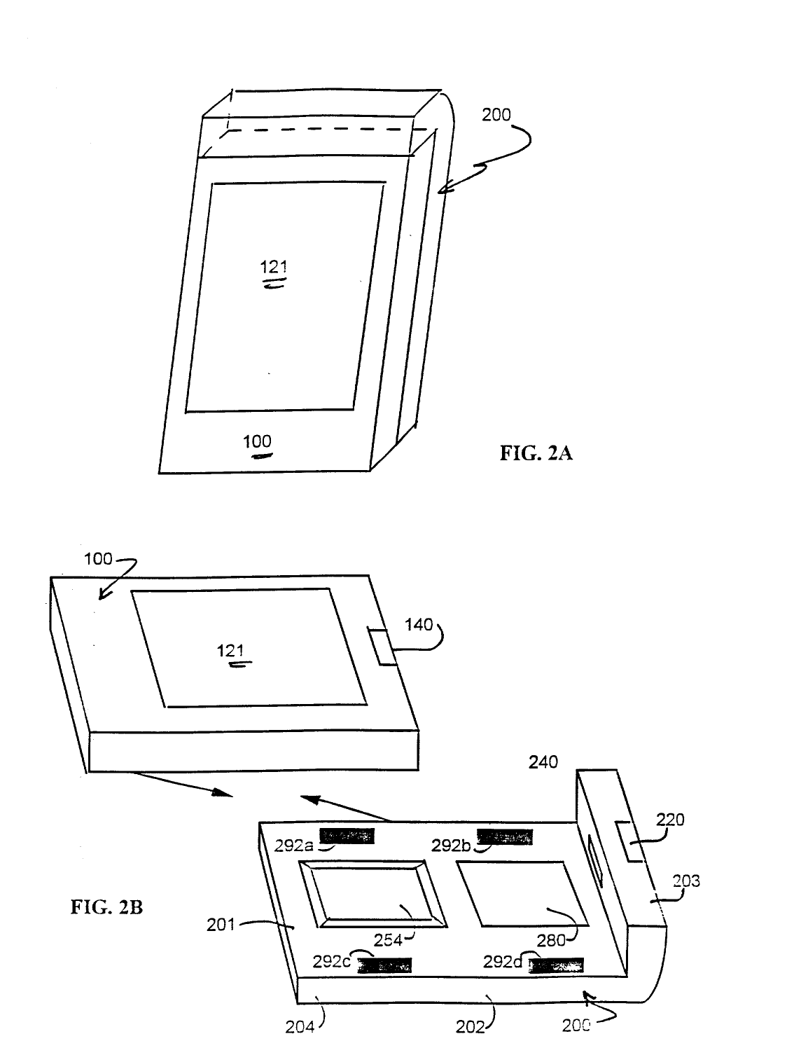

Referring now to FIGS. 2A and 2B, a partial perspective view of an exemplary embodiment of the PDA attachment unit 200 for attachment to the PDA 100 is shown. Structurally, the PDA attachment unit 200 could be of any practical size and shape and mounted to a top surface 201, any side surfaces 202 including a front surface 203, a bottom surface 204, or even partially wrapped around the PDA 100. If made small enough, the PDA attachment unit 200 could be made a part of and contained within the enclosure of the PDA 100 itself.

Herein, as shown in one embodiment, a top surface 201 of the PDA attachment unit 200 is physically coupled to a bottom surface of the PDA 100 via a plurality of fasteners 292a, 292b, 292c and 292d. In one embodiment, these fasteners 292a-292d are VELCRO® tabs that mate with corresponding tabs on the bottom surface of the PDA 100. When mounted on the PDA 100, the PDA communications transceiver 240 is positioned adjacent to and in front of the communications transceiver 140 for dependent IRDA communications. The multimedia transceiver 220 is positioned at the front side of the PDA attachment unit 200 for easy aiming at the multimedia equipment to be controlled. Besides other logic, the processing unit 230 is placed on a circuit board 280 and the battery 250 is placed within a battery storage compartment 254.

It is contemplated that the PDA attachment unit 200 could also be implemented with a slot into which the PDA 100 is placed. Physical buttons then could be placed on the PDA attachment unit 200 to give users an ability to select screen objects by physical pushing a dedicated button as an alternative to touching certain areas of the PDA touch screen 122 itself.

Referring back to FIG. 1, as it relates to controlling multimedia equipment, computer software loaded on the computer 400 is written to gather user data for controlling a wide variety of multimedia equipment. In particular, the software takes in user data about multimedia equipment and translates it to a form that can be utilized by the PDA software and the PDA attachment unit 200. In one embodiment, the computer software resides on a desktop or laptop computer running WINDOWS 95® operating system or more recent version and is written to handle communications through its output port 460 (e.g., serial or USB port) and with the output port 160 of the PDA 100. The purpose of the computer 400 is to gather data from a user about the multimedia equipment the user wishes to control and convert the data to a database format that can be recognized by the PDA software (referred to as “PDA databases”) as shown in Appendix A. The computer 400 further allows the user to download the PDA databases to the PDA 100 via a temporary connection between the computer output port 460 and PDA output port 160.

Referring now to FIG. 3, an exemplary embodiment of a flowchart outlining the operations of software residing in the PDA attachment unit 200 (e.g., nonvolatile memory 234) is shown. As previously described in FIG. 1, the PDA attachment unit 200 communicates with the PDA 100 via transceivers 240 and 140, which may be IRDA transceivers. Moreover, the PDA attachment unit 200 communicates with the multimedia equipment 300 via transceivers 220 and 320, which may support long distance infrared signaling in one embodiment.

In many situations, to conserve power, the processor of the PDA attachment unit is in SLEEP mode, waiting for a communications interrupt from the PDA (decision block 260). When this occurs, the processor “wakes up” to gather and store the data in the internal attachment memory 235 such as volatile memory 236 (decision block 262). The stored data is then analyzed to determine whether the stored data is a transmit command and whether such command requires waiting for a response for the targeted device (decision block 264).

If the command is a “No Wait” transmit command, the data is formatted for infrared transmission to the multimedia equipment (decision block 266). After transmission is complete, an acknowledgment is sent from the PDA attachment unit to the PDA via the PDA communications transceiver (decision block 268). The processor remains in its operational state unless no activity is detected for a predetermined period of time (e.g., 2 or 3 seconds). At that time, the processor returns to a SLEEP mode (decision block 260).

If the command is a “Transmit and Wait” command (decision block 270), the data is formatted for infrared transmission to multimedia equipment (decision block 272). After the transmission is complete, a timer is started. The timer may be internal to the PDA attachment unit or provided from a clock signal from an external unit such as the PDA. The multimedia transceiver is then polled for a response from the multimedia equipment (usually the result of a status request) as shown in decision block 274. If the timer times out before the response is received, the processor remains in its operational state but again returns to the SLEEP mode if no activity is detected after a predetermined period of time (decision block 276). However, if the response is received before a timer times out, the multimedia equipment response data is gathered and sent to the PDA 100 (decision blocks 274, 276 and 278). Usually, the response data is displayed by the PDA for review by the user. The processor remains in its operational state unless it detects no activity for the predetermined period of time. At that time, the processor returns to a SLEEP mode (decision block 260).

If the command is a “Learn” command (decision block 280), the processor goes into a LEARN mode and polls the multimedia transceiver of the PDA attachment unit for incoming data (decision blocks 282 and 284). The incoming data is usually provided from an infrared remote control provided from the multimedia equipment manufacturer. If the incoming data is received (decision block 284), the incoming data is formatted and sent to the PDA (decision block 288). The PDA 100 can exit from the LEARN mode at any time with an interrupt (decision block 286). After this operation, the processor remains in its operational state unless no activity is detected for the predetermined period of time. At that time, the processor returns to a SLEEP mode (decision block 260).

If the command is a “Reprogram” command, the processor goes into a PROGRAM mode and establishes a communication pathway, for this embodiment, between both the PDA attachment unit and the PDA as well as the PDA and the computer (decision block 290). Of course, if reprogramming can be accomplished by the PDA, then only the communication pathway between the PDA attachment unit and the PDA would need to be established (decision block 292). If, however, the command data from the PDA 100 is unrecognizable, the processor remains in a normal operational state until it returns to SLEEP mode (decision block 260).

With reference to both FIGS. 3 and 4, an exemplary embodiment of a flowchart of a programmable method of the operations from the PDA software standpoint. As shown in FIG. 4, when a user selects a screen item at the PDA display (decision block 502), the PDA software receives information contained in one or more records stored in one or more databases residing in the internal memory of the PDA (decision block 504). The information within the record(s), corresponding to the selected screen object, provides information for the PDA processing unit to handle and complete a certain operation. For example, as a result of the user selection, the database lookup may either cause a screen to be displayed or cause a set of commands to be sent to the PDA attachment unit (decision blocks 506 and 526).

If the commands are sent to the PDA attachment unit, a command counter is set to zero and a first command is sent to the PDA attachment unit 200 (decision blocks 508, 510 and 512). The PDA attachment unit receives and formats the first command into a command recognizable by the multimedia equipment. The formatted first command is then transmitted to the multimedia equipment (decision block 514).

If a response is not expected (decision block 516), the PDA attachment unit sends an acknowledgment that a command has been sent to the PDA (decision block 518). Since the PDA will not be expecting a response from the PDA attachment unit, it will perform a look-up operation to determine if all commands for the set of commands have been sent to the multimedia equipment (decision block 510). If not, the next command is sent to the PDA attachment unit and this iterative operation is performed as discussed in decision blocks 512, 514, 516, 518 and 520 (discussed below). If all commands have been sent, the screen item selection operations controlled by the PDA software cease until a new PDA screen item is selected (decision block 502).

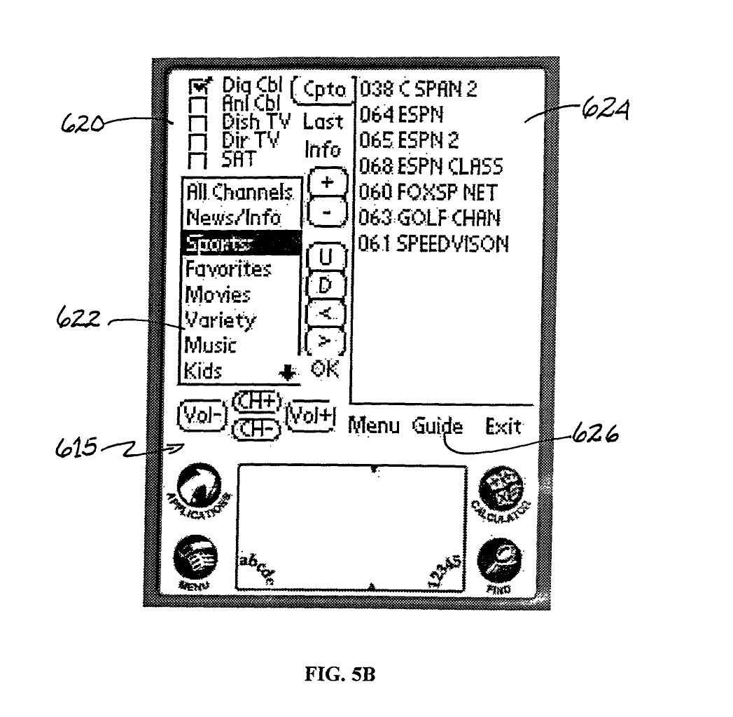

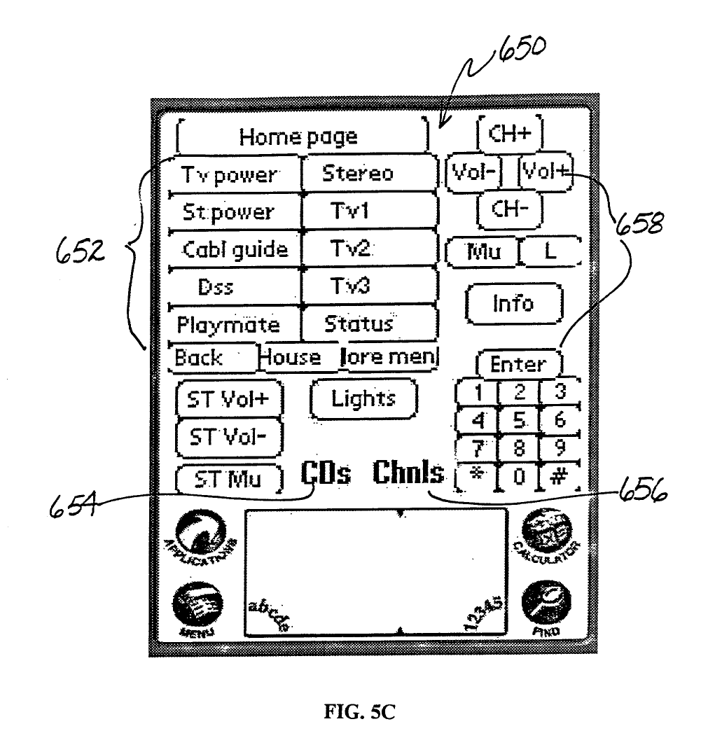

If a response is expected (decision block 516), the PDA attachment unit will wait for a reasonable period of time to get the multimedia equipment response and send it to the PDA (decision block 520). The PDA will be expecting a response (decision block 522) and, upon receipt, displays a message associated with the response to the user for this embodiment (decision block 524). Then, the screen item selection operations controlled by the PDA software cease until a new PDA screen item is selected (decision block 502). Typical responses from the multimedia equipment include status information such as room temperature, security status, and the like. Referring now to FIG. 5A, an exemplary embodiment of a PDA screen showing a CD jukebox selection application is shown. Herein, the PDA software CD selection screen 600 is generated by the PDA. When a user selects a CD title within area 606, the PDA software performs a look-up for the songs of the CD in a database and then displays them to the user in a song display area 608. When a user selects a song title within the song display area 608, the PDA software looks up the CD's location (e.g., a multimedia changer where it is located, Disc # location in the changer, and track #) from a database. The Changer#, Disc# (2, 83 in this example) is displayed in area 610 as shown.

The PDA software then looks-up the data from the appropriate PDA database needed by the PDA attachment unit to instruct the CD changer to play the selection. The PDA software then sends the data to the PDA attachment unit, as described above for FIGS. 3 and 4 to control the changer. The user can alphabetically cycle through CD titles in small (>, <) or larger (>>, <<) -increments through selection of arrow buttons 602 and can select specific CD title start letters at buttons 604 to display different sets of CD titles within area 606. Selection of the “Cpto” button 614 takes the user to a general multimedia equipment control screen as shown in FIG. 5C. A volume control button 612 is also provided.

Referring to FIG. 5B, an exemplary embodiment of a PDA screen showing a channels selection screen 615 controlled by the PDA software running on the PDA is shown. If not already selected at area 620, a user selects the type of channel control multimedia equipment that he or she wishes to control. Different types of channel control multimedia equipment include digital cable, analog cable, and a variety of different wireless or satellite communications.

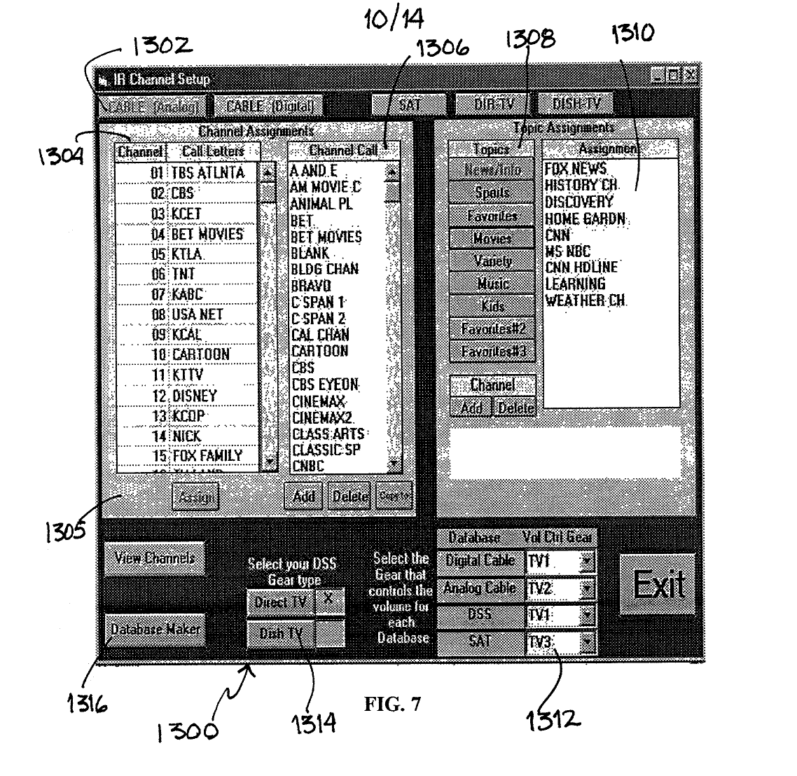

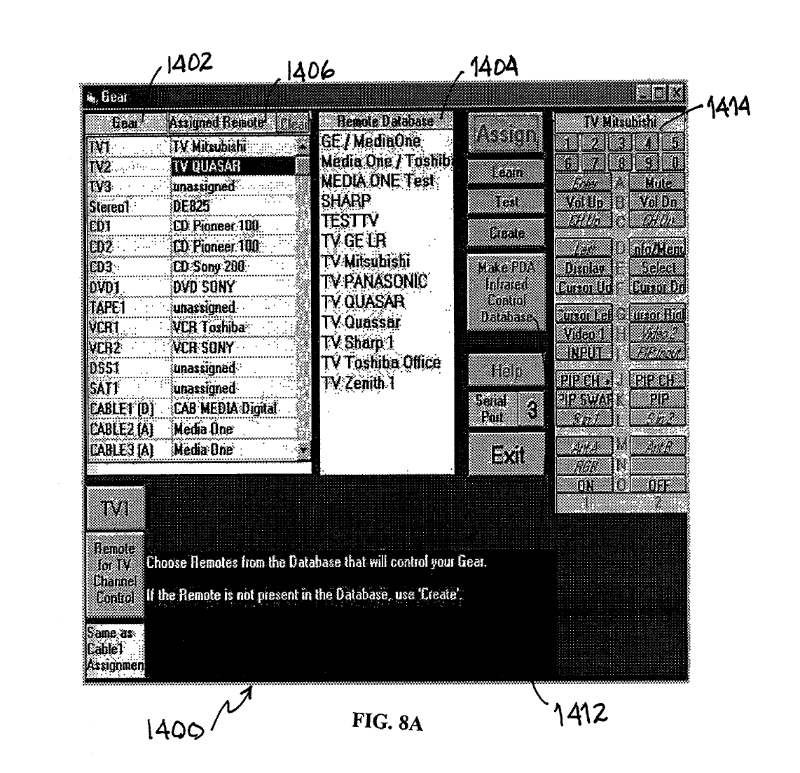

Moreover, the channels selection screen 615 includes a channel topic menu area 622 that includes channel topics by category (e.g., Sports, News, etc.) as well as all channels and favorites programmed by the user. The particular channels are entered into a channel database using a channel set-up screen as described in FIG. 7. The PDA software looks up the channels of the topic from a channel database and then displays them to the user at topic station area 624. When a user selects a specific channel, such as ESPN2 for example, the PDA software looks up the commands to send from a database that will be sent to the PDA attachment unit to tune the multimedia equipment to the selected channel. The PDA software then sends the data to the PDA attachment unit 200, as described above for FIGS. 3 and 4. The selection of the Guide and Exit buttons 626 provides commands for tuning to and exiting from the guide screen of a television. The selection of the Menu button provides commands to produce a menu screen for parameter adjustment of the multimedia equipment.

Referring to FIG. 5C, an exemplary embodiment of a PDA screen showing a general multimedia equipment control screen 650 is shown. A user selects buttons 652 associated with multimedia equipment to be controlled and the equipment's functions are looked-up in a database for screen display 650. For example, upon selecting one of the multimedia equipment types identified by buttons 652, remote control buttons 658 are now selectable to enable the PDA to issue commands to the multimedia equipment in order to adjust various features controlled by the multimedia equipment. These features may include, but are not limited or restricted to television or cable box volume control (Vol+, Vol−), stereo volume control (ST+, ST−), increment/decrement channel numbers or (CH+, CH−), mute (Mu, ST Mu), specific channel selection (virtual keypad 0-9, enter), status for networked or wireless appliances/control boxes and the like.

Upon selection of the areas described above, the PDA software then looks up the command(s) to be sent to the PDA attachment unit 200 as described above in FIGS. 3 and 4. Of course, the user can go to the CD screen by selecting “CDs” area 654 or go to channels screen by selecting the “Chnls” area 656.

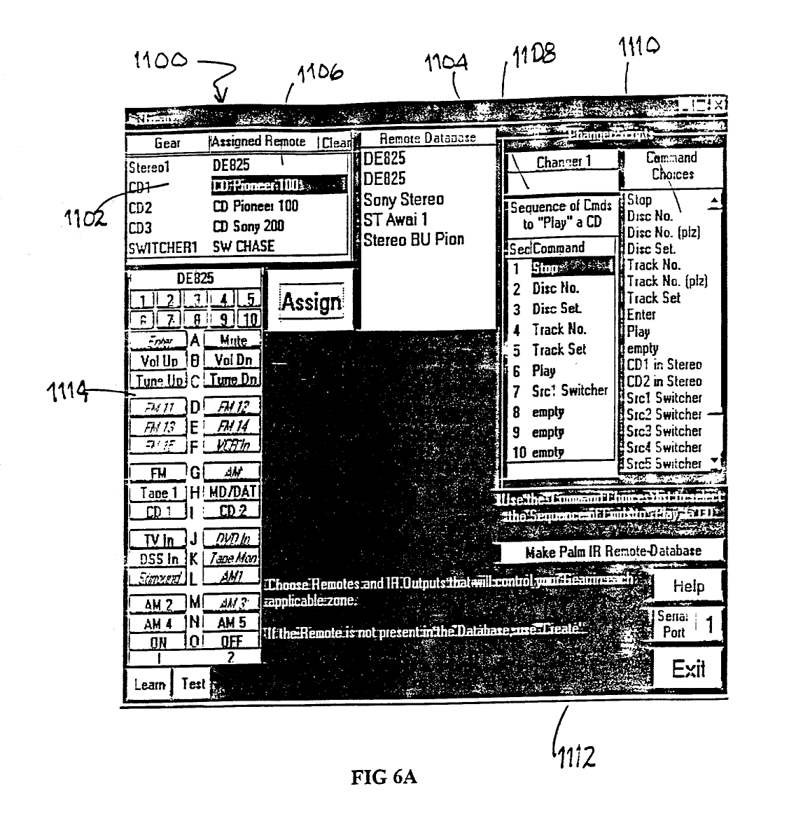

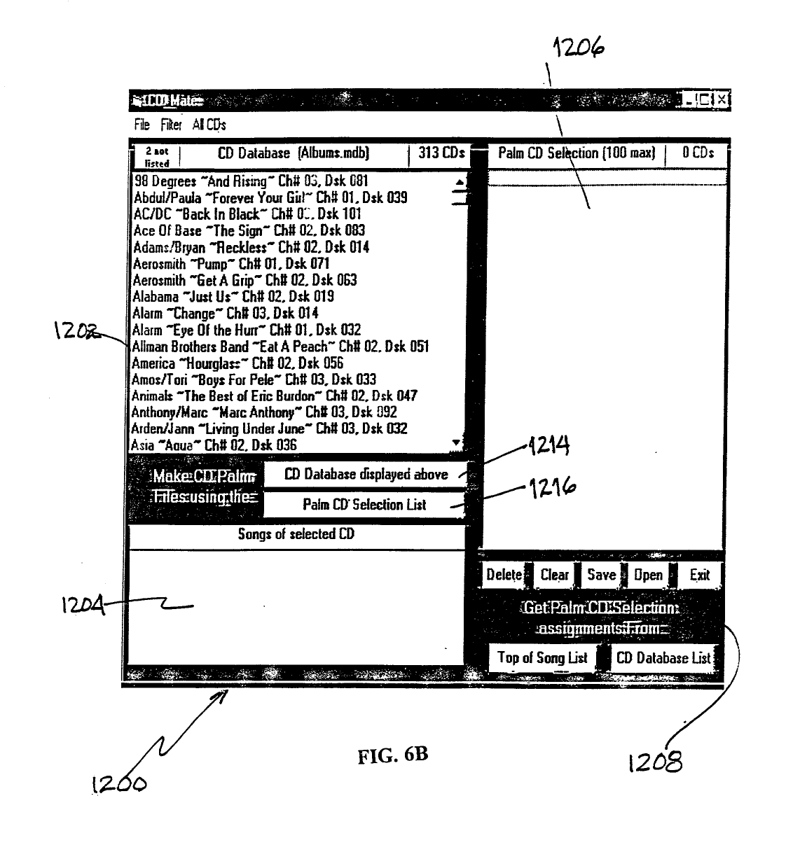

Referring now to FIGS. 6A-10, exemplary embodiments of the computer software screens related to the setup process of gathering data from a user about his multimedia equipment, converting the data to PDA databases that can be used by the PDA software and download to the PDA is shown. For purposes of this description, the term “gear” shall be construed as multimedia equipment.

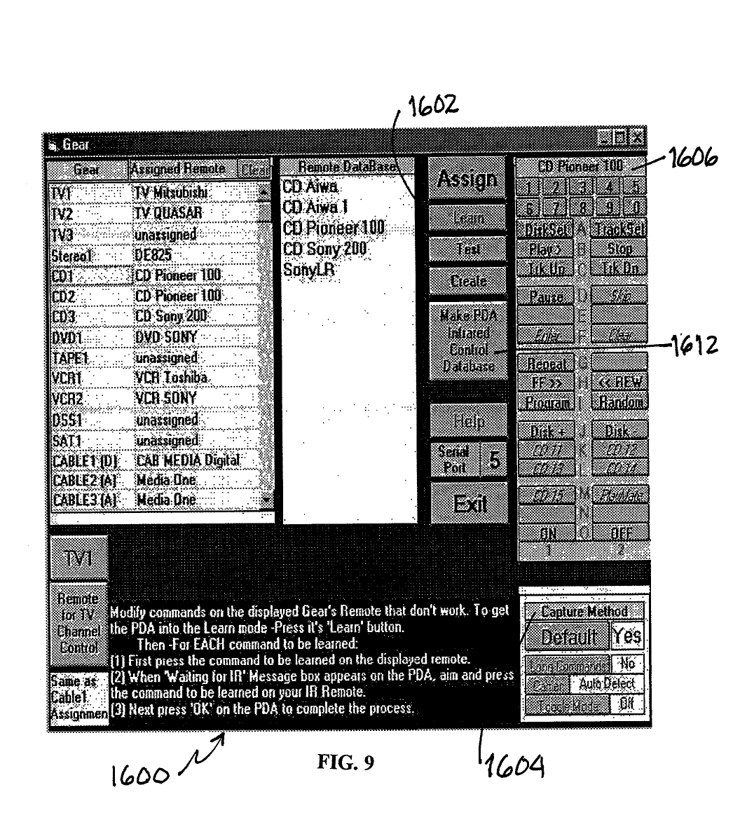

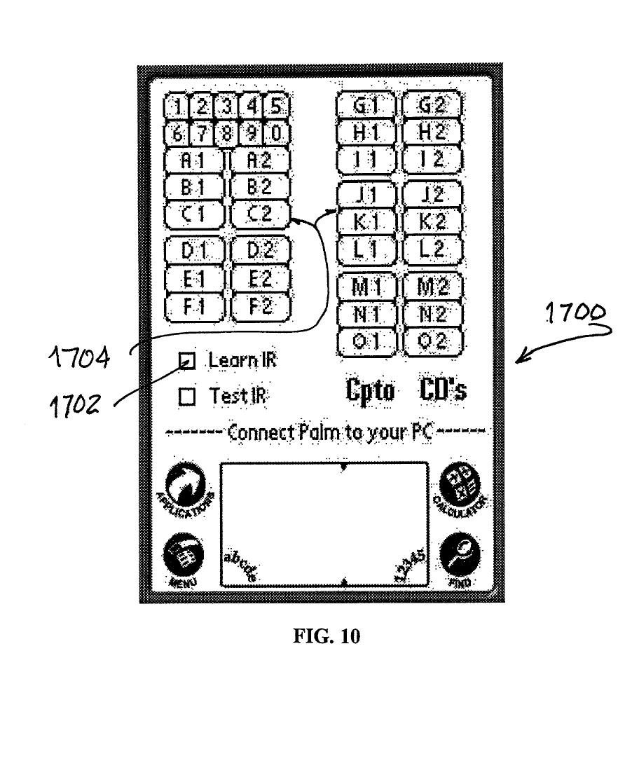

FIGS. 6A and 6B illustrate the setup process for gathering user data for the CD jukebox application described with FIG. 5A above. Now referring to FIG. 6A, a Gear Setup selection screen 1100 for gathering data about stereo equipment to be controlled by the user is shown. The user selects a type of gear that he or she wishes to assign, such as a stereo receiver for example, from the gear list 1102. A computer database of remotes for the gear type selected is generated and displayed in the remote database list 1104. The user then selects the appropriate gear from the remote database list 1104. In response, the computer accesses a database and obtains a visual representation 1114 of the remote control. Of course, the user can perform this process for other stereo components such as CD players or even a switching mechanism. In the event that a type of gear is not contained in the remote database list 1104, or certain (IR) commands are missing from the remote control representation 1114, the commands can be learned (as will be described later with FIGS. 9 and 10).

Referring still to FIG. 6A, an exemplary embodiment of a computer screen illustrating how the user can select how a CD changer is controlled by selecting commands from the Command Choices list 1110 to build the sequence of commands list 1108 to “Play” certain songs from a CD is shown. This becomes the scripting used by the PDA software after it is downloaded to the PDA as part of a PDA database built when the “Make Palm IR Remote Database” button 1112 is selected.

Referring to FIG. 6B, an exemplary embodiment of a computer setup screen 1200 showing a partial list of CD data that can be appropriately converted to one or more database types that the PDA software can recognize is shown. A user creates a list of CDs either by selecting the CDs from database of CDs (e.g., database in accordance with MICROSOFT® ACCESS®) by hand entry or downloading individual CD titles from the Web. The user would also need to enter the location of each CD. For example, CD list 1202 shows CD “Hour Glass” by America in Changer 2 and disk slot location 56. The user makes a PDA compatible database from his entire CD title list 1202 by selecting the “Make CD Palm Files using the: CD Database Displayed above” button 1214. The user then downloads (HotSyncs) the created databases from the computer to the PDA. The databases created are ArtistsN.pdb, SongsN.pdb, and Locate5.pdb which are outlined in Appendix A.

Alternatively, certain entries forming a subset of the CD list 1202 may be produced in the “Palm CD Selection” list 1206. The user makes a PDA compatible database from the subset of the CD title list 1202 by selecting the “Make CD Palm Files using the: Palm CD Selection List” button 1216. As each CD is selected 1202 for the subset, its title is displayed in the Palm CD Selection list 1206, and its song tracks are displayed in the Songs of Selected CD list 1204. This allows the user to see the songs of each CD as he selects them. Using the button group 1208, the user may choose to Delete a CD from list 1208, Clear the list 1206, Save the list 1206 for later use, or Open a previously saved list 1206.

Referring now to FIG. 7, an exemplary embodiment of a computer channel setup screen 1300 showing how a partial list of channels and channel scripts that can be pragmatically converted to PDA type databases. The channel setup screen is used to gather user data about the channels to be controlled and how the user wishes to control them. Using the multimedia equipment type buttons 1302, the user first selects a type of multimedia equipment that controls his channels on a television. A list of channel call acronyms 1306 and their channel number associations 1304, if any, are presented in window 1305. The user can make modifications to the assignments 1304, depending on the area of the country the user lives.

Furthermore, as shown, the user can also assign channel categories for the various Topics 1308 from the call letter acronym list 1304, which when selected, appear in the Topic Assignment 1310 list. If the user, for example, has digital cable box that controls the channels on one television and also has a DSS Dish-TV that controls the channels on another television, the user would then do the selection process for both digital cable and Dish-TV databases. Since it is unknown what TV or stereo gear is controlling the volume for each of the channel control gear 1302, the user should select them from the Vol Ctrl Gear drop down lists 1312. The Vol. Ctrl Gear 1312 selections are used for the Vol.− And Vol+ buttons in FIG. 5B.

When the selection and assignment process for all user channel gear is complete, the user can select the “Database Maker” button 1316 to create the necessary channel PDA databases used by the PDA software for the PDA channels application described above with FIG. 5B. The user then downloads (HotSyncs) the created databases from the computer to the PDA. The user can also select “Select your DSS Gear type” 1314 to tell the software the user preference of what page to display when DSS 652 (FIG. 5C) is selected.

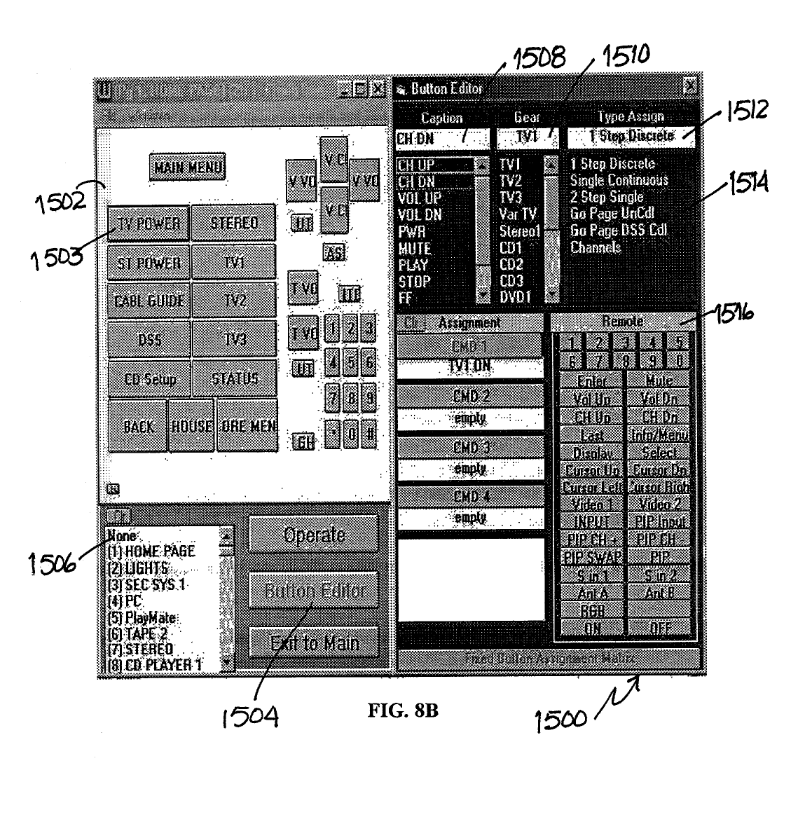

Referring now to FIGS. 8A and 8B, an exemplary embodiment of a setup process for gathering user data for the multimedia equipment control screen described with FIG. 5C is illustrated. As shown in FIG. 8A, a Gear Setup selection screen 1400 for gathering data about a user's multimedia equipment is produced for display. The user first selects a piece of gear he or she wishes to assign, like a first television (TV1) from the gear list 1402. After selection, a computer database of remotes for the gear type selected appears in the remote database list 1404. The user then selects the particular gear from the remote database list 1404 and displays a visual representation of a remote control 1414. The user continues this process for each multimedia equipment type that will be controlled by the PDA attachment unit.

When the selection process is complete, the user can select the “Make PDA Infrared Control Database’ button 1412 to make the necessary PDA 100 databases. The user then downloads (HotSync) the created databases from the computer to the PDA.

Of course, if a manufacturer's equipment is not in the remote database list 1404 or commands are missing from the representation of the remote control 1414, the commands can be learned (as will be described later with FIGS. 9 and 10).

Now referring to FIG. 8B, an exemplary embodiment of a computer setup screen 1500 showing how commands and captions are assigned to areas on general purpose multimedia equipment control pages/screens is shown. The user first selects the page to be edited or assigned by selecting the page from the page list 1506. To enter an EDIT mode, the user then selects the “Button Editor” button 1504. Thereafter, any selected buttons 1502 associated with multimedia equipment to be controlled or equipment functions can now be edited.

If, for example, the TV POWER button 1503 is selected, the user is able to change its caption by typing in a new caption in text box 1508, choose the generic gear from which to get command(s) from the gear list 1510, select the type of command assignment to make button 1503 by selecting the assignment type from the Type Assign list 1512. The Type Assign list 1512 indicates the sequence of commands needed to perform a certain function. As shown, the “1 Step Discrete” instruction sequence is shown to be selected and a first television (TV1) is selected as the appropriate gear. The user selects the command assignments from the generic remote list 1516. The user can continue this process for any other assignments to be made. The assignment changes are reflected in the PDA databases created when the user selects “Make PDA Infrared Control Database” button 1412 of FIG. 8A.

FIGS. 9 and 10 and a portion of FIG. 3 illustrate the sequence of events when it is necessary to learn an infrared command from a manufactures multimedia equipment's remote that is not in the database. To illustrate the learning mechanism, the user connects the computer 400 to the PDA 100 via their output ports 460 and 160, respectively. The user should already be on the gear setup selection screen 1600 (see also FIG. 8A) and then, upon selection of the LEARN area on the gear setup selection screen 1600 to transfer to a Learn/Test screen 1700 (FIG. 10) on the PDA 100. The user should then select the “Learn IR” 1702 option which results in the PDA software sending a command to the computer software that in turn, causes the Learn function on the computer to be selected. The user then selects a command to be taught from buttons 1704 on the PDA. These buttons correspond to the commands on a visual representation of a remote control 1606. As an example, a representation of a remote control for a PIONEER® CD player is shown.

In particular, correspondence of which button(s) 1704 to select is given by the letter correspondence A1 to O1, A2 to O2 or the number buttons themselves 0 to 9 to the reference lettering next to the particular buttons of the remote control representation 1606. For example, to learn the Skip button for the remote control 1606, the user would press the D2 button 1704 on the learn screen 1700. The selection of the D2 button 1704 causes the PDA software to tell the computer which button was selected and to issue a learn command to the PDA attachment unit 200 which results in the action taken at decision block 282 through 288 described earlier in the flowchart of FIG. 3. Learned command data from the PDA attachment unit 200 is passed to PDA 100 where, in turn, the Learn command data (e.g., IR data) is passed to the computer 400. The computer software stores the data for the Skip command learned. This data as well as other command IR data may be converted to a database format that can be used by the PDA software when “Make Infrared Control Database” button 1612 is selected.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

APPENDIX A

| Note 1 | There are currently 5 different PDA applications which use the PDA Attachment and utilize | | |
|---|---|---|---|
| | different combinations of databases described below | | |
| | PDA App | General Description | |
| | S_PlayCDs | CD Jukebox application: where when a song of a CD is selected, an infrared trigger | |
| | | containing the Changer#, Disc Location# within the Changer, and Track# is sent | |
| | | to a home automation system (from Dancraft), which in turn sends the appropriate | |
| | | commands to the Changer# to “play” the chosen song (PDA screen of FIG. 5A) | |
| | | Relational Databases used: ArtistsN.pdb, SongsN.pdb, Locate5.pdb | |
| | | General Description | |
| | CD_Smate | Same as S_PlayCDs above, but is stand alone, in that infrared commands are sent | |
| | | directly to the changer to be controlled, and therefore, does not require the | |
| | | Dancraft Home Automation System, i.e. the user just points the Multimedia PDA | |
| | | Attachment Unit at the changer to be controlled (PDA screen of FIG. 5A). | |
| | | Additional Infrared database required is Cdrmotes.pdb | |
| | | General Description | |
| | S_Chnls | A Channel selection application: where when a channel acronym is selected or a a trigger | |
| | | channel guide type selection is made, an infrared trigger containing the selection information is sent | |
| | | to a home automation system (from Dancraft), which in turn sends the appropriate | |
| | | commands to the multimedia equipment to either change the channel or display the channel | |
| | | info. (PDA screen of FIG. 5B) | |
| | | Relational Databases used: Allchann.pdb, Topichan.pdb | |
| | | General Description | |
| | S_Cmdo | A general multimedia equipment control application with up to 128 pages of control | |
| | | functions, where when a control function is selected, an infrared trigger containing the | |
| | | Zone#, Page#, and Button# of the function selected is sent to | |
| | | to a home automation system (from Dancraft), which in turn sends the appropriate | |
| | | infrared commands to the multimedia equipment to be controlled to perform the | |
| | | chosen function. One PDA screen page is shown in FIG. 5C. | |
| | | Relational Databases used: GoPages.pdb, Captions.pdb | |
| | | General Description | |
| | PalmCmdo | This application combines of S_Chnls and S_Cmdo (with 12 pages vs. 128) | |
| | | into one application that controls the multimedia equipment directly, | |
| | | and therefore, does not require the Dancraft Home Automation System, i.e., the user | |
| | | just points the Multimedia PDA Attachment Unit at the multimedia equipment to be | |
| | | controlled (PDA screens of FIG. 5B and 5C). This application has up to 12 (vs. 128) pages of | |
| | | Relational Databases used: Allchann.pdb, Topichan.pdb, Cremotes.pdb | |
| Note 2 | Since the Palm OS can only recognize ANSI characters, all ASCII bytes are stored in Double Byte format XY | | |
| | Let V = value (0 to 255) of the ASCII byte to represented by 2 bytes X and Y then, 1st let Xa = Int(V/256) | | |
| | then X = Xa + 65, and Y = V − 256 * Xa + 65 which are now always ANSI characters | | |
| Note 3 | ANSI text strings, like CD Titles and captions are stored in normal single byte format | | |
| Note 4 | The IR command format used is as follows: Byte 1 is the number of bytes in the command, Byte 2 represents the | | |
| | infrared carrier frequency, Byte 3 represents the demodulated base pulse, the remaining bytes represent | | |
| | the infrared commands bit pattern. | | |
| Database | ArtistsN.pdb {N can be 1 to 10, Nmax = Int(# of user CDs/100) + 1} | | |
| Records, Length | 100 Records, 32 bytes per record | | |
| Template | 3 byte sequential dbkey + 29“Z”s | | |
| Records 1 to 100 | records are alphabetically filled by artist and each contains: | | |
| (Single Byte format) | Byte Location | | |
| | 1 to 12 | 12 Letter Artist name | |
| | 13 to 24 | 12 Letter CD Title | |
| | 25 to 28 | 4 Letter record location of 1st Track in SongsN.pdb | |
| | 29 | 1 Letter Changer number (“1” to “3”) | |
| | 30 to 32 | 3 Letter Disc# | |
| Database | SongsN.pdb {N can be 1 to 10, Nmax = Int(# of user CDs/100) + 1} | | |
| Records, Length | 1200 Records, 17 bytes per record | | |
| Template | 4 byte sequential dbkey + 13“Z”s | | |
| Records 1 to 1200 | records are alphabetically ordered by artist and each contains: | | |
| (Single Byte format) | Byte Location | | |
| | 1 to 12 | 12 Letter song title | |
| | 13 to 15 | 3 Letter CD record # in ArtistsN.pdb | |
| | 16 & 17 | 2 Letter Track# | |
| Database | Locate5.pdb | | |
| Records, Length | 200 Records, 5 bytes per record | | |
| Template | 3 byte sequential dbkey + “ZZ” | | |
| Records 1 to 200 | contain the location and artist string for the 5 CDs that are be displayed at a time | | |
| (Single Byte format) | Byte Location | | |
| | 1 to 3 | The accumulative Record Number location in the ArtistsN.pdb databases for the 5 CDs to be displayed | |
| | 4 & 5 | the corresponding 1st 2 letters of the artist name | |
| Database | Topichan.pdb | (Single Byte format) - Channels by topic | |
| Records, Length | 1200 Records, 13 bytes per record | | |
| Template | 4 byte sequential dbkey + 9“Z”s | | |
| Record 1 | Byte Location | DB1 means Digital Cable, DB2 = Analog Cable, DB3 = SAT, DB4 = DirTV, DB5 = DishTV | |
| | 1 to 4 | DB1: 4 byte string for the record location for channel topic #1 | |
| | 5 & 6 | DB1: 2 byte string for the number of records to display for channel topic #1 | |
| | 7 to 10 | DB1: 4 byte string for the record location for channel topic #2 | |
| | DB1: 11 & 12 | 2 byte string for the number of records to display for channel topic #2 | |
| | 13 | unused | |
| Records 2 to 5 | have the same format as record #1, but are for DB1 Topics 3 through 10 | | |
| Records 6 to 10 | have the same format as records 1 to 5, but are for DB2 Topics 1 through 10 | | |
| Records 11 to 15 | have the same format as records 1 to 5, but are for DB3 Topics 1 through 10 | | |
| Records 16 to 21 | have the same format as records 1 to 5, but are for DB4 Topics 1 through 10 | | |
| Records 21 to 25 | have the same format as records 1 to 5, but are for DB5 Topics 1 through 10 | | |
| Records 26 to 35 | are the ten 13 Letter Topic headings which are the same for each DB# | | |
| Records 36 to 1200 | are the channel listings for each DB# using the format | | |
| | Byte Location | | |
| | 1 to 10 | 10 Letter Channel Title or acronym | |
| | 11 to 13 | 3 Letter Channel number | |
| Database | Allchann.pdb | (Single Byte format) All channels in each DB type | |
| Records, Length | 1200 Records, 13 bytes per record | | |
| Template | 4 byte sequential dbkey + 9“Z”s | | |
| Record 1 | Byte Location | DB1 means Digital Cable, DB2 = Analog Cable, DB3 = SAT, DB4 = DirTV, DB5 = DishTV | |
| | 1 to 4 | DB1: 4 byte string for the record location for channel topic names beginning with letters A to C | |
| | 5 & 6 | DB1: 2 byte string for the number of records to display for channel topic names beginning with letters A to C | |
| | 7 to 10 | DB1: 4 byte string for the record location for channel topic names beginning with letters D to G | |
| | DB1: 11 & 12 | 2 byte string for the number of records to display for channel topic names beginning with letters D to G | |
| | 13 | unused | |
| Records 2 to 4 | have the same format as record #1, but are for DB1 channel topic names beginning with letters H to K, | | |
| | L to O, P to S, T to V, and W to Z respectively | | |
| Records 5 to 8 | have the same format as records 1 to 4, but are for DB2 | | |
| Records 9 to 12 | have the same format as records 1 to 4, but are for DB3 | | |
| Records 13 to 16 | have the same format as records 1 to 4, but are for DB4 | | |
| Records 19 to 20 | have the same format as records 1 to 4, but are for DB5 | | |
| Records 21 to 1200 | are the channel listings for each DB# using the format | | |
| | Byte Location | | |
| | 1 to 10 | 10 Letter Channel Title or acronym | |
| | 11 to 13 | 3 Letter Channel number | |
| Database | Gopages.pdb | | |
| Records, Length | 128 Records, 42 Bytes per record | | |
| Template | 3 byte sequential dbkey + 39“Z”s | | |
| Records 1 to 128 | 14 sets of 3 digit letter goto page numbers, if “000” its not a goto page (Used for “Var” buttons 1 to 14) | | |
| (Single Byte format) | Byte Location | | |
| | 1 to 3 | Var button 1 goto page# | |
| | 4 to 42 | Var button 2 to 14 goto page numbers | |
| Database | Captions.pdb | | |
| Records, Length | 128 Records, 140 Bytes per record | | |
| Template | 3 byte sequential dbkey + 137“Z”s | | |
| Records 1 to 128 | 14 sets of 10 Letter Captions for the “Var” buttons | | |
| (Single Byte format) | Byte Location | | |
| | 1 to 10 | Var button 1 caption | |
| | 11 to 140 | Var button 2 to 14 captions | |
| Database | Cdrmotes.pdb | | |
| Records, Length | 80 Records, 90 Bytes per record | | |
| Template | 3 byte sequential dbkey + 29“XYZ”s | | |
| Records 1 to 3 | Contain IR command pointers and the CD Changer scripts for changers 1 to 3. Each record has the following format | | |
| (Double byte | Byte Location | Function | |
| format) | 1 to 4 | Stop -Pointer | (1) Palm has Ch#, Disc#, & Track# to play |
| | 5 to 8 | Disk Set -Pointer | (2) Get Rec# CH# in Cdremote and store the 44 byte string H2$ |
| | 9 to 12 | Track Set -Pointer | (3) Palm starts at Step 1 @ Byte 35 & set B = 35 |
| | 13 to 16 | Enter -Pointer | (4) Read V the value in B |
| | 17 to 20 | Play -Pointer | (5) if V > 0 AND V < = 13 then |
| | 21 to 24 | Switcher Ch# -Pointer | look up the 2 bytes starting at V in H2$ to get the cdremote |
| | 25 to 28 | Misc. -future use | Rec# using the lookup format, then send the command |
| | 29 to 68 | 0 to 9 -Pointers | elseif V = FFH or EFH then |
| | 69 & 70 | Step 1 -of changer script | look up each Rec# needed corresponding to the Disc# (Or Tract#) |
| | 71 & 72 | Step 2 -of changer script | (value at bytes 15 to 34) and send the command(s) |
| | to | to | elseif V = 0 then your done |
| | 87 & 88 | Step 10 -of changer script | (6) Set B = B + 1: If B < = 10 then goto (4) |
| | 89 & 90 | unused | |
| | Changer script | | |
| | Step Values | | |
| | 1 | Send Stop | if the value V is 1 to 13, look up the 2 bytes starting at V in H2$ to get |
| | 3 | Send Disc Set | the Rec# for the IR Command to send from Cdremote.pdb |
| | 5 | Send Track Set | |
| | 7 | Send Enter | If value V is FFH or EFH use Disc# or Track# to tell you where the #Cmd |
| | 9 | Send Play | rec#s are located. They will be in H2$ in location 15 to 34 |
| | 11 | Switcher Ch# | |
| | 13 | Misc. | |
| | OOH | Do nothing | |

| | FFH | Send the Disk No. (get the IR Commands from bytes 15 to 34 above) | |
|---|---|---|---|
| | EFH | Send the Track No. | |
| Records 4 to 80 | Contain the IR commands themselves for the CD related multimedia equipment. | | |
| Database | Cremotes.pdb | | |
| Records, Length | 289 Records, 104 bytes per record | | |
| Template | 4 byte sequential dbkey + 25 “WXYZ”s | | |
| | Records | Use Summary | |
| | 1 to 4 | Channel Command pointers for Digital Cable, Analog Cable, DSS, SAT | |
| | 5 to 10 | PalmCmdo Var button pointers for pages 1 to 12 | |
| * | 11 | Page pointers for Fixed buts (value = 1 to 3) for 12 pages | |
| | 12 to 14 | PalmCmdo fixed button pointers (3 fixed sets) | |
| * | 15 to 31 | 14 Var Captions for 12 pages = 168 captions. At 10 captions/record = 17 records | |
| | 32 to 281 | IR command space | |
| | 282 to 289 | Script space | |
| | * note records 11, & 15 to 31 are the only records using the single byte format | | |
| Records 1 to 4 | Digital Cable, Analog Cable, DSS, and SAT IR command location pointers: each with the following format | | |
| (Double byte | Byte Location | Command Pointers for: | |
| format) | 1-4 | 0 | Pointers when converted to single byte format |
| | 5-8 | 1 | are 2 bytes long and point to the start location of the |
| | 9-12 | 2 | IR command: B1 = its Record location − 13 |
| | 13-16 | 3 | B2 = its byte start location within the record |
| | 17-20 | 4 | |
| | 21-24 | 5 | |
| | 25-28 | 6 | |
| | 29-32 | 7 | |
| | 33-36 | 8 | |
| | 37-40 | 9 | |
| | 41-44 | Enter | |
| | 45-48 | CH + | |
| | 49-52 | CH− | |
| | 53-56 | Last | |
| | 57-60 | Info | |
| | 61-64 | Page Up | either point to the start location |
| | 65-68 | Page Dn | of the IR command, if |
| | 69-72 | Up | B1 = its Record location − 31 |
| | 73-76 | Dn | B2 = its byte start location within the record |
| | 77-80 | Left | if B1 = 0 then its unassigned |
| | 81-84 | Right | |
| | 85-88 | Select | |
| | 89-92 | Menu | |
| | 93-96 | Guide | |
| | 97-100 | Exit | |

| | |
|---|---|
| 101, 102 | 2 * E + A, For a channel#: If E = 1 send enter, If A = 0 send leading 0's |

Record 5

| (Double byte | Byte Location | Command assignment for | | | |
|---|---|---|---|---|---|
| format) | 1-4 | Pg1, Var 1 | Pointers when converted to single byte format | | |
| | 5-8 | Pg1, Var 2 | are 2 bytes long (B1, B2) and mean the following: | | |
| | 9-12 | Pg1, Var 3 | if B1 = 0 then the button is unassigned | | |
| | 13-16 | Pg1, Var 4 | if B1 = 1 to 250 then it points to its IR command IR assignment location | | |
| | 17-20 | Pg1, Var5 | where B1 = its Record location − 31 | | |
| | 21-24 | Pg1, Var 6 | B2 = its byte start location within the record | | |
| | 25-28 | Pg1, Var 7 | if B1 = 251 then it's a goto page assignment and B2 = the page# to go to | | |
| | 29-32 | Pg1, Var 8 | If B1 = 252 to 255 then it's a script (multi command) assignment | | |
| | 33-36 | Pg1, Var 9 | then the script record location Rec is: | | |
| | 37-40 | Pg1, Var 10 | Rec = 2 * (B1-251) + Int(B2/128) | | |
| | 41-44 | Pg1, Var 11 | and the start location P within the record Rec is: | | |
| | 45-48 | Pg1, Var 12 | P = B2 − 2 * Int(B2/128) | | |
| | 49-52 | Pg1, Var 13 | | | |
| | 53-56 | Pg2, Var 1 | | | |
| | 57-60 | Pg2, Var 2 | | | |
| | 61-64 | Pg2, Var 3 | Var 0 button always returns to Main Menu | | |
| | 65-68 | Pg2, Var 4 | | | |
| | 69-72 | Pg2, Var 5 | Var Button Location Ref | | |
| | 73-76 | Pg2, Var 6 | | Var 0 | |
| | 77-80 | Pg2, Var 7 | Var 1 | | Var 6 |
| | 81-84 | Pg2, Var 8 | Var 2 | | Var 7 |
| | 85-88 | Pg2, Var 9 | Var 3 | | Var 8 |
| | 89-92 | Pg2, Var 10 | Var 4 | | Var 9 |
| | 93-96 | Pg2, Var 11 | Var 5 | | Var 10 |
| | 97-100 | Pg2, Var 12 | Var 11 | Var 12 | Var 13 |
| | 101-104 | Pg2, Var 13 | | | |

| Records 6 to 10 | are for pages 3 to 12 and have the same format as Record 5 | | |
|---|---|---|---|
| Record 11 | Byte Location | | |
| | 1 to 12 | 12 Page pointers for fixed buts (values 1 to 3); “A” = 1, “B” = 2, “C” = 3 | |
| | 13 to 17 | Vol source to use for each DB: “A” = TV1, “B” = TV2, “C” = TV3, “D” = Stereo | |
| | 18 to 104 | free | |
| Record 12 | Fixed Button set #! lookup IR command pointers (Right side of FIG. 5C) | | |
| (Double byte | Byte Location | Command assignment for | |
| format) | 1-4 | 0 | |
| | 5-8 | 1 | |
| | 9-12 | 2 | Pointers when converted to single byte format |
| | 13-16 | 3 | are 2 bytes long (B1, B2) and mean the following: |
| | 17-20 | 4 | B1 = its Record location − 31 |
| | 21-24 | 5 | B2 = its byte start location within the record |
| | 25-28 | 6 | if B1 = 0 then its unassigned |
| | 29-32 | 7 | |
| | 33-36 | 8 | |
| | 37-40 | 9 | |
| | 41-44 | TV Vol− | |
| | 45-48 | TV Vol+ | |
| | 49-52 | TV Mute | |
| | 53-56 | ST Vol− | |
| | 57-60 | ST Vol+ | |
| | 61-64 | ST Mute | |
| | 65-68 | TV CH + | |
| | 69-72 | TV CH− | |
| | 73-76 | Enter | |
| | 77-80 | Last | |
| | 81-84 | Info | |
| | 85-88 | * | |
| | 89-92 | # | |
| Records 13 & 14 | Same as Record 12 except they are the assignments for fixed button sets 2 and 3 | | |
| | | Note Fixed button set to use depends upon the page your on which is | |
| | | looked up in record 11. Generally, they correspond to being on | |
| | | a TV1, TV2, or a TV3 functional page | |
| Records 15 to 31 | are the 14 Var Captions for 12 pages = 168 captions. At 10 captions/record = 17 records | | |
| Record 15 | Byte Location | | |
| | 1 to 10 | Var Button 1 caption for page 1 | |
| | 11 to 100 | Var captions for buttons 2 to 10 for page 1 | |
| | 101 to 104 | unused | |
| Record 16 | 1 to 40 | Var captions for buttons 11 to 14 for page 1 | |
| | 41 to 100 | Var captions for buttons 1 to 6 for page 2 | |
| | 101 to 104 | | |
| Records 17 to 31 | Continue this caption lookup pattern for remaining pages of “Var buttons” | | |
| Records 32 to 281 | Contain the IR commands themselves | | |
| Records 282 to 289 | Contain the scripts for this Var buttons that are assigned scripts | | |
| | Starting with the byte pointed to by the command pointer (see Record 5 above when B1 is 252 to 255) | | |
| | Bytes 1 & 2 | The number of Commands to send | |
| | Bytes 3 to 6 | Pointer to 1st command | Note: these pointers have the same meaning as |
| | Bytes 7 to 10 | Pointer to 2nd command | those defined for B1, B2 in Record 5 above |
| | Etc. | | and therefore, not only point to commands, and |
| | | | cause a page change, but also point to scripts. |

I claim:

1. A system for controlling electronic equipment comprising:
a) an attachment unit configured to receive a PDA, the PDA being mechanically attached to the attachment unit, and the PDA and attachment unit being in electronic communication,
b) a computer for assimilation of control information for the electronic equipment being controlled and to translate that control information to a form which can be downloaded to and utilized by PDA and the attachment unit software, the translated control information being transmitted from the computer to the PDA,
c) the PDA attachment unit being in communication with the electronic equipment to control the operation of said electronic equipment and to adjust the functioning of said equipment.
d) software residing in the attachment unit controlling the transfer of information between the PDA and the electronic equipment.

2. The system of claim 1 wherein the electronic equipment comprises multimedia devices.

3. The system of claim 2 wherein the multimedia devices comprise music playing equipment, television equipment, equipment to receive radio signals.
